(19) United States
(12) Patent Application Publication
(10) Pub. No.: US 2017/0354249 A1
(43) Pub. Date: Dec. 14, 2017

(54) HERMETICALLY SEALABLE STORAGE CABINETS

(71) Applicant: Sear Latifzada, Foothill Ranch, CA (US)

(72) Inventor: Sear Latifzada, Foothill Ranch, CA (US)

(21) Appl. No.: 15/181,202

(22) Filed: Jun. 13, 2016

(51) Int. Cl. A47B 71/00; E06B 7/232

(52) U.S. Cl. CPC A47B 71/00; E06B 7/232; A47B 2220/0077

(57) ABSTRACT

In accordance with one embodiment, a hermetically sealable food storage cabinet for storing dry food is disclosed. The hermetically sealable food storage cabinet includes a body/housing with a storage compartment, a hinged door for opening and closing over an opening of the storage compartment, and a magnetic gasket coupled to the hinged door for providing a substantial air-tight seal between the hinged door and the body/housing of the storage cabinet.

### FIELD

The embodiments relate generally to storage cabinets.

### BACKGROUND

Open kitchens have become popular interior designs in homes. However, storage space provided by cupboards is often sacrificed to provide the open kitchen design to an adjacent room, such as a family room. A pantry to store dry food near a kitchen is often unavailable as well. Storage demands for dry food can be exacerbated as families grow in size within the same home.

To avoid more frequent grocery shopping, food is often stored in a garage of a home. Moreover, pet food is often stored in a garage even when there is sufficient storage in a kitchen for human food. However, garages and the storage cabinets therein are often not sealed well from outdoor elements such as dirt, insects and rodents. The food stored in a garage can become dirty from the infiltration of dirt and eaten by insects or rodents.

Accordingly, there is a need for improved dry food storage.

### BRIEF SUMMARY

The embodiments of the invention are summarized by the claims that follow below.

### BRIEF DESCRIPTIONS OF THE DRAWINGS

FIG. 1A illustrates a sealable storage cabinet in an open door configuration/status.

FIG. 1B illustrates the sealable storage cabinet of FIG. 1A in a closed door configuration/status.

FIG. 2 illustrates a cross sectional view of portions of the hinged door 116 and a side of the cabinet housing with the sealable storage cabinet in the closed configuration as shown in FIG. 1B.

FIGS. 3A-3B illustrate corner portions of an embodiment of a magnetic gasket assembly coupling to a hinged door.

FIGS. 4A-4C are cross sectional views of various embodiments of the magnetic gasket assembly coupled to the hinged door.

FIG. 5 illustrates a magnified view of a side hinge coupled to outside surfaces of a side panel and the hinged door.

FIG. 6 illustrates a sealable storage cabinet with double doors each of which has the magnetic gasket assembly coupled to the hinged door to seal over the two open faces in the cabinet.

FIG. 7 is an exploded view of a top hinge that may be used for the hinged door a double door sealable storage cabinet or hinged doors of a double door sealable storage cabinet.

FIGS. 8A-8B are exploded views of a bottom hinge that may be used for the hinged door a double door sealable storage cabinet or hinged doors of a double door sealable storage cabinet.

FIG. 9 illustrates a magnified view of a portion of a light bar that is used to light the interior of the sealable storage cabinet.

FIG. 10 illustrates a sealable storage cabinet with a top hinged door and short front side for easy access.

FIG. 11 illustrates a sealable storage cabinet with a top hinged door and front side windows to readily view the food storage level of dry food stored in the sealable storage cabinet.

### DETAILED DESCRIPTION

In the following detailed description, numerous specific details of embodiments are set forth in order to provide a thorough understanding. However, it will be obvious to one skilled in the art that the embodiments may be practiced without these specific details. In other instances well known methods, procedures, components, and circuits have not been described in detail so as not to unnecessarily obscure aspects of the embodiments.

A hermetically sealable storage cabinet for housing dry foods and other items is disclosed. The hermetically sealable storage cabinet includes a housing with a storage compartment, a door for opening and closing an opening into the storage compartment, and a magnetic sealing gasket for providing a substantial air-tight seal around the door when in the closed configuration/state. Without refrigeration, the hermetically sealable storage cabinet is suitable for storing non-refrigerated and dry food goods, such as in the garage of a home. The hermetically sealable storage cabinet protects the stored food goods from dust and insects. Accordingly, the hermetically sealable storage cabinet may also be referred to herein as a hermetically sealable food storage cabinet.

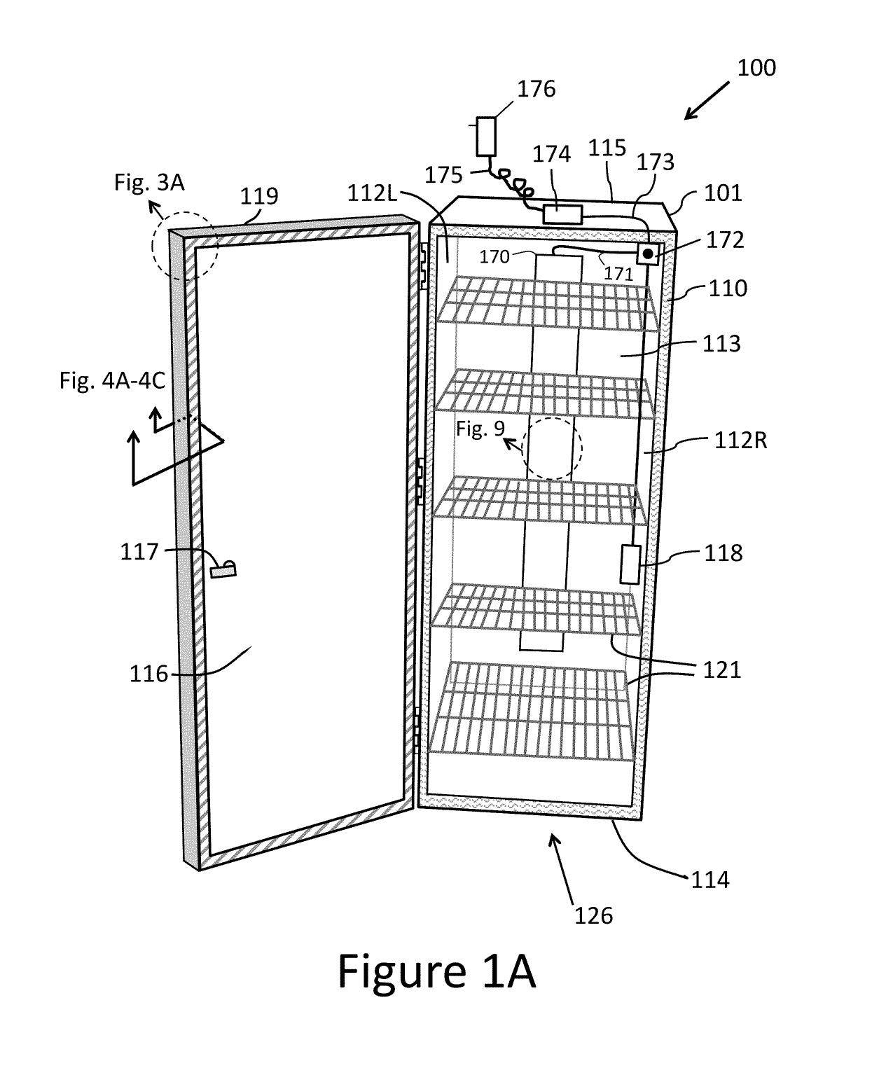

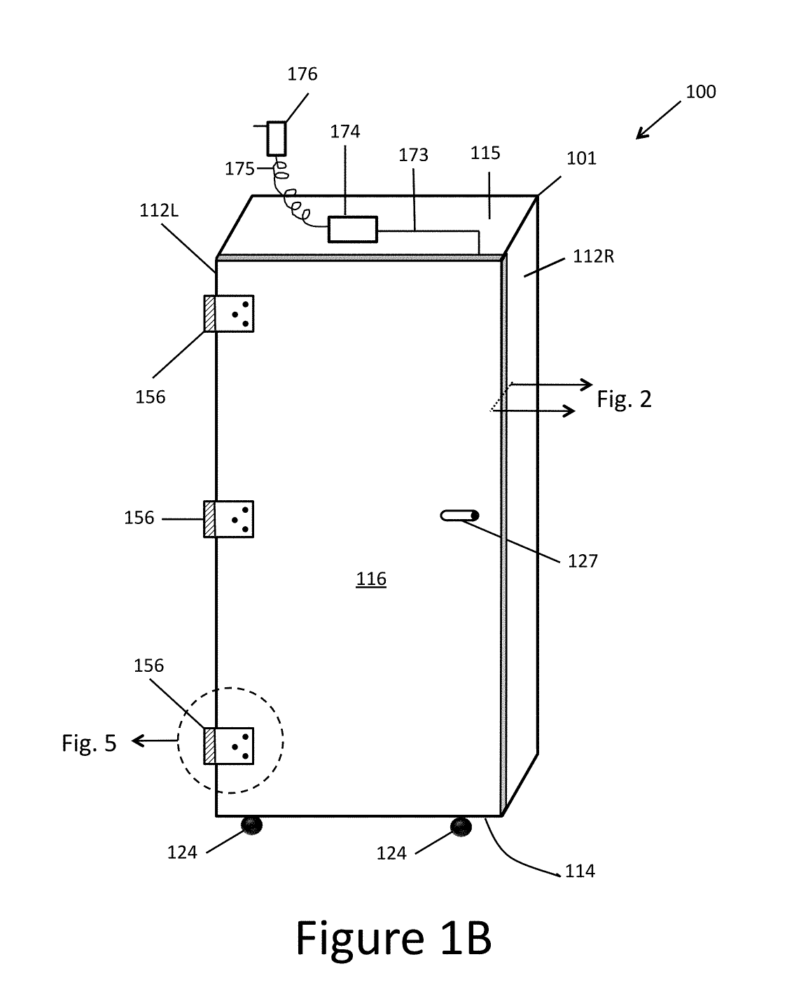

Referring now to FIGS. 1A-1B, a perspective view of a hermetically sealable food storage cabinet 100 with a single capacity is shown in an open door configuration. In accordance with some embodiments, the size of the food storage cabinet 100 may be approximately 72 inches (6 feet) tall, 48 inches (4 feet) wide, and 24 inches (2 feet) deep so that it is readily mounted to a wall of a garage. In other embodiments, the storage cabinet 100 may have other dimensions. The hermetically sealable food storage cabinet 100 may also stand alone and include a ballast coupled to the bottom or base 114 of the cabinet. When in a closed door configuration/state, such as shown in FIG. 1B, a substantial air tight seal is formed around the door by a magnetic gasket assembly. This tight seal prevents insects from entering the container and ravaging the food stored therein.

Generally, the food storage cabinet 100 includes two side walls 112L,112R, a bottom 114, and a top 115 all coupled to a back wall 111. Edges of the two side walls 112L,112R, the bottom 114, and the top 115 form a rectangular edge 110 that surrounds a sealable open face 126. The food storage cabinet 100 further includes a hinged door 116 coupled to one of the two side walls 112L,112R. The hinged door 116 is configured to cover over the opening of the sealable open face 126 to seal the food storage cabinet. The two side walls 112L,112R, the back wall 113, the bottom 114, and the top 115 form a housing or body 101 of the food storage cabinet 100.

The food storage cabinet 100 has two configurations or states. An open configuration/state is shown in FIG. 1A. A closed configuration/state shown in FIG. 1B. In the open configuration/state shown in FIG. 1A, an individual can access non-refrigerated and dry food goods (not shown) contained within the food storage cabinet 100. In the closed configuration/state, the door 116 of the food storage cabinet 100 is shut, forming a substantial air-tight seal between and around the edges of the door 116 and the open face 126.

Components of the food storage cabinet 100, including the housing or body 101, may be fabricated from wood, plastic (e.g., polypropylene), or metal. Portions of the hinged door 116 may also be fabricated from wood, plastic or metal. For ready movability, a set of caster wheels 124 may be pivotally coupled to the bottom 114 of the cabinet 100.

As shown in FIG. 1A, there may be one or more shelves 121 located inside the food storage cabinet 100. Like the cabinet, the shelves 121 may be constructed from plastic. To allow light to shine through the shelves 121, the shelves may have openings formed therein in a grid configuration. The shelves 121 may be adjustable in position with slots being included in the inner portion of the sides 112L,112R of the cabinet. Alternatively or additionally, brackets may be coupled to the inner portion of the sides 112L,112R and of the shelves 121 to hold them in a more rigid configuration.

The hinged door 116 has a lockable handle 127 with a latch 117 that mates with a catch 118 coupled to an inner portion of a side wall 112L,112R. Accordingly, the hinged door 116 is configured to be locked over the opening of the open face 126 of the food storage cabinet in the closed configuration.

In the closed configuration/state, the hinged door 116 is hermetically sealed (substantially air tight) around edges of the door 116 and the open face 126 by a magnetic gasket assembly 119. The magnetic gasket assembly 119 substantially keeps dirt, dust, and bugs out of the inside of the food storage cabinet.

### Magentic Gasket Assembly

The food-storage cabinet provides a tight seal (substantially air tight) between the hinged door 116 and the housing or body 101 of the food storage cabinet 100. The seal prevents insects from gaining entry and consuming the food stored within. The seal also prevents dust and dirt from infiltrating into the inner portion of the food storage cabinet 100.

Referring now to FIGS. 1A, 2, and 3A-3B, the substantial air-tight seal is achieved by a magnetic gasket assembly 119 that is coupled around the periphery edges of the hinged door 116. The magnetic gasket assembly 119 interfaces with the edges of the two side walls 112L,112R, the bottom side 114, and the top side 115 around the open face 126 of the cabinet 100.

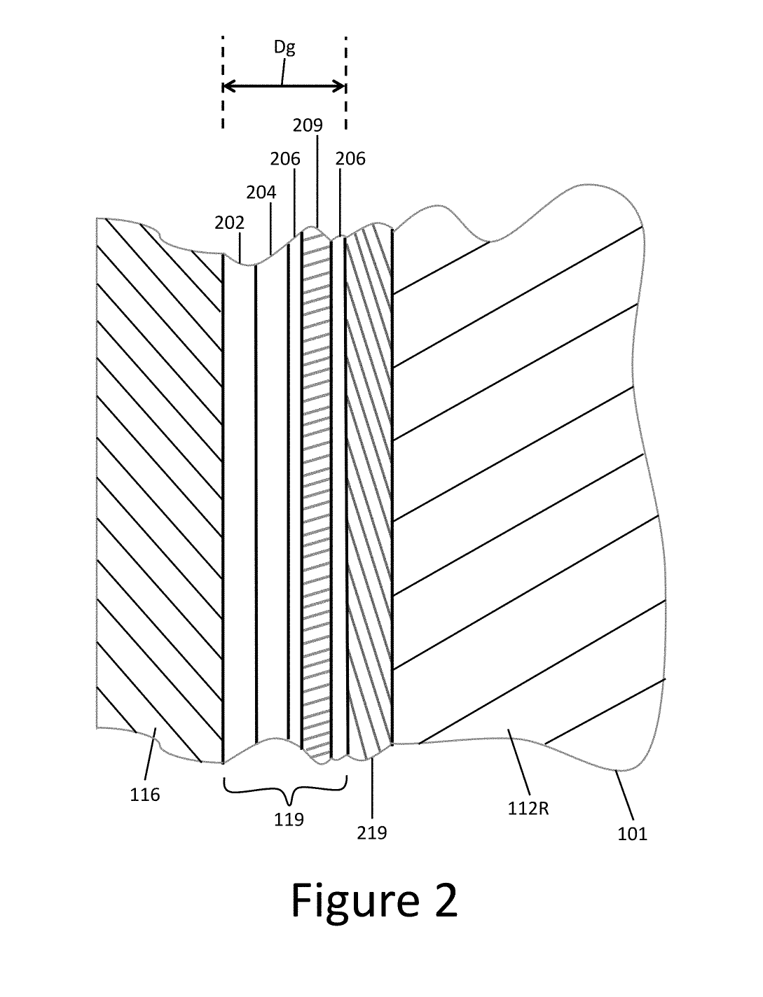

In FIG. 2, a cross sectional view of portions of the hinged door 116 and a side 112R of the housing 101 of the cabinet 100 is shown in the closed configuration. FIG. 2 shows the magnetic gasket assembly 119 coupled near an edge of the hinged door 116. The magnetic gasket assembly 119 is releasably and magnetically coupled near an edge of the side 112R of the housing 101. A metal attracting strip 219 is coupled near the edge of the side 112R of the food storage cabinet to magnetically attract the flexible magnet in the magnetic gasket assembly. Unless the cabinet is metal, the metal attracting strip 219 runs around the edges of the two side walls 112L,112R, the bottom side 114, and the top side 115 around the open face 126 of the cabinet 100. The metal attracting strip 219 along the edge of the housing 101 interfaces with the magnetic gasket assembly 119 coupled along the periphery edge of the door 116.

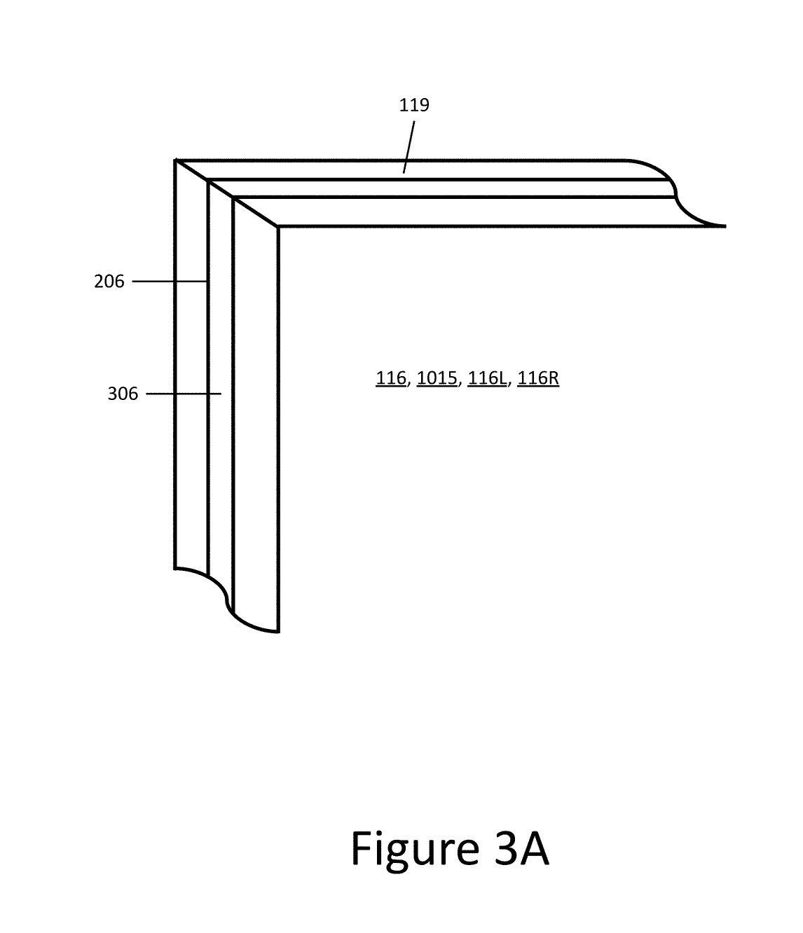

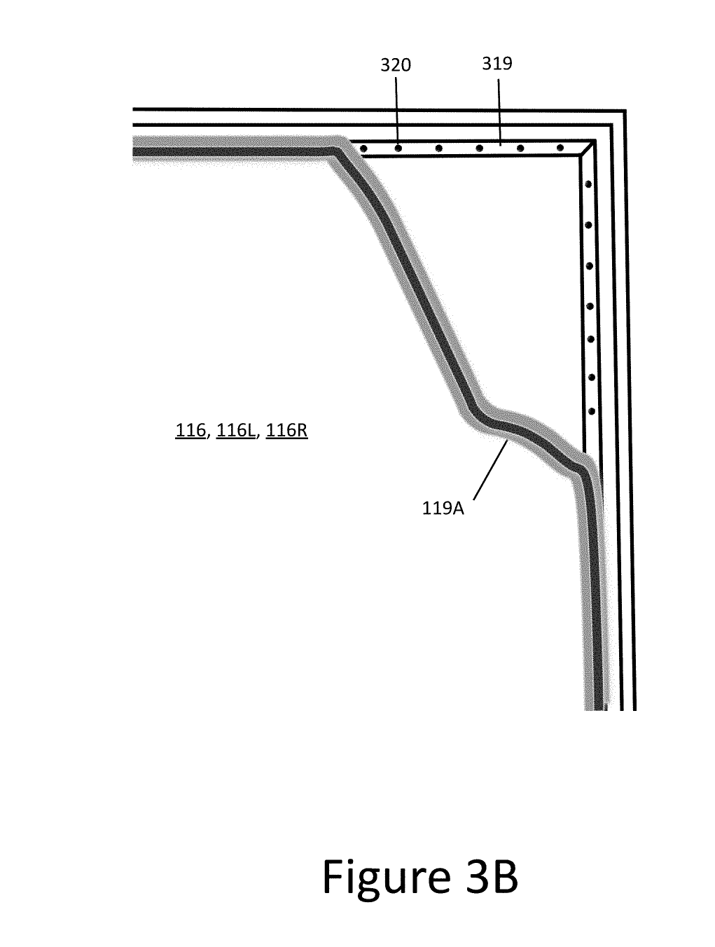

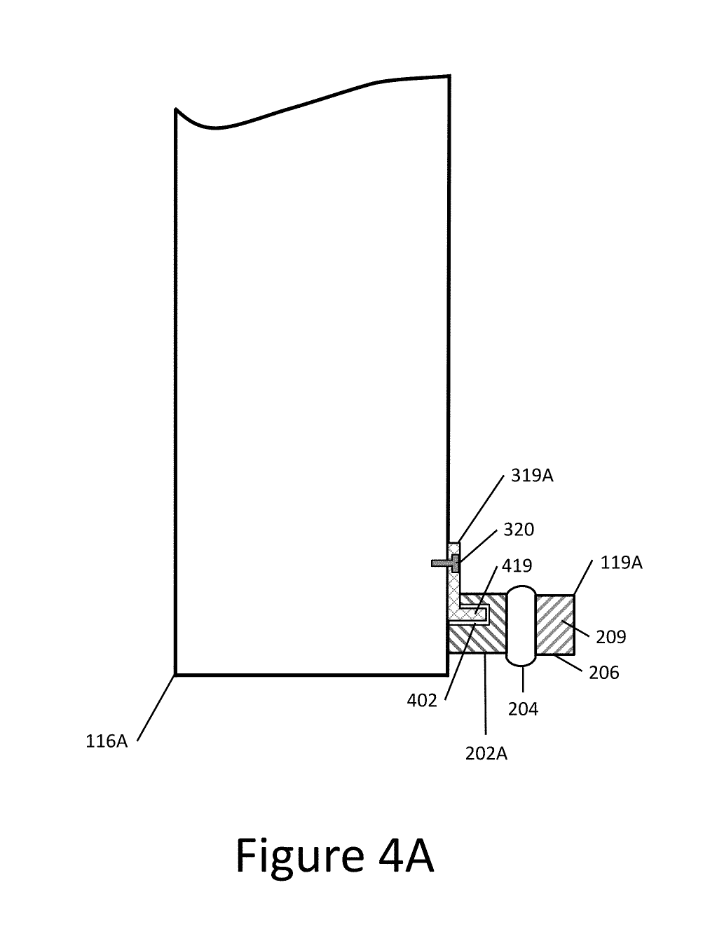

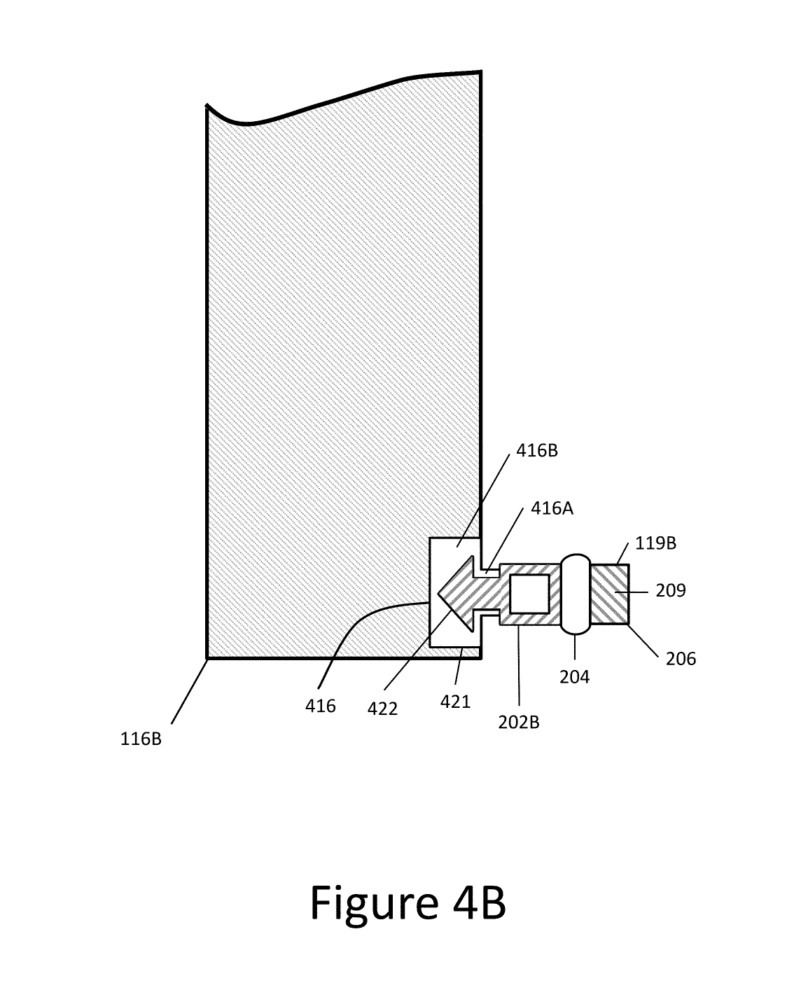

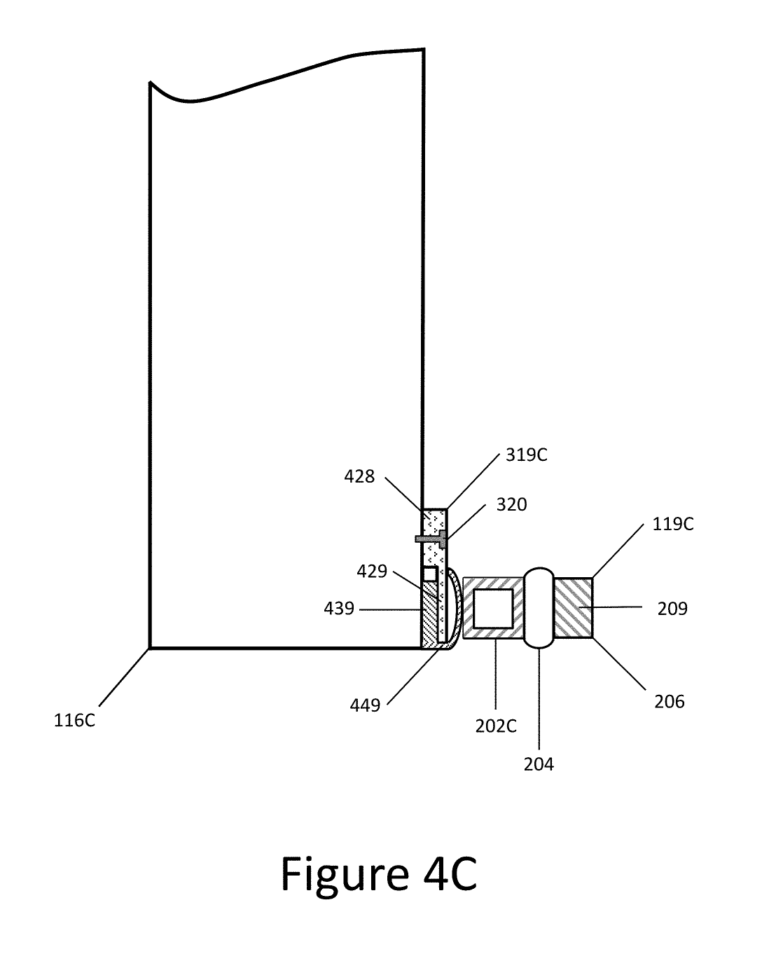

The magnetic gasket assembly 119 includes a flexible magnet strip 209 coupled to flexible integrated gasket components 202,204,206. The gasket components 202,204,206 are flexible to adapt to provide the air tight seal around and between the door and the housing 101 of the cabinet. As better seen in FIGS. 4A-4C, the interfacing gasket component 206 may wrap around the flexible magnetic strip 209 like a rectangular cylinder to hold the flexible magnetic strip 209 coupled to the spring gasket component 204 that is coupled to the mounting gasket component 202. An outer compliant or pliable surface of the gasket component 206 interfaces and seals against the edge of the housing 101 to provide the substantial air tight (hermetic) bug resistant seal. An outer surface 306 of the gasket component 206 is shown in FIG. 3A.

Referring to FIG. 2, the gasket components 202,204 are flexible and act like an accordion to expand into the variable gap between the door 116 and the edge of the housing 101. The gasket 119 has a variable thickness Dth that expands and contracts as needed to fill the variable gap when the door is in the closed configuration. Accordingly, the flexible gasket components 202,204,206 are formed of a flexible (compliant or pliable) solid material such as rubber (natural or synthetic—neoprene) or silicone, for example.

The magnetic gasket assembly 119 may be coupled to the door 116 in various ways. A magnetic gasket may be mounted to the door by snapping a snap-in fastener into a groove, by pushing a groove into or on a fastener, screwing a screw through a fastening portion, pressing a retainer strip into an opening, or gluing with a high temperature adhesive.

Referring now to FIG. 3B, in accordance with some embodiments, a retaining strip 319 is coupled to the hinged door 116 around the periphery of the door. The retaining strip 319 is coupled near each of the four edges of the door forming a rectangular frame ready to receive an embodiment of the magnetic gasket assembly 119. The retaining strip 319 is fastened to the door 116 with a plurality of fasteners 320. The fasteners 320 may be screws, bolts, or nails, for example. The grooved magnetic gasket assembly 119A, when coupled to the retaining strip 319 and door, forms a rectangular sealing frame to seal against the rectangular edge 110 of the housing 101.

FIG. 4A illustrates a cross section of a grooved magnetic gasket assembly 119A coupled to a retaining strip 319A and a door 116A. The grooved magnetic gasket assembly 119A includes the mounting gasket component 202A with a groove 402. The retaining strip 319A has an L-shaped cross section with a tongue protrusion 419 that protrudes out from the surface of the door 116A. The tongue protrusion 419 of the retaining strip 319A mates with the groove 402 in the mounting gasket component 202A of the grooved magnetic gasket assembly 119A.

Referring now to FIG. 4B, a cross section of a pluggable magnetic gasket assembly 119B is shown coupled to the hinged door 116B. The hinged door 116B includes a rectangular groove 416 around the periphery near the edges of the door. The groove 416 includes a narrow surface groove 416A that leads into an expansion groove 416B.

To couple it to the door 116B, the pluggable magnetic gasket assembly 119B includes an expansion plug 422 that is configured to be received by the expansion groove 416B through the narrow surface groove 416A. The expansion plug 422 is coupled to a neck 421 that is in turned coupled to the mounting gasket component 202B. The magnetic gasket assembly 119B includes the spring gasket component 204 coupled to the mounting gasket component 202B and the interfacing gasket component 206 coupled to the spring gasket component 204. The interfacing gasket component 206 includes the flexible magnetic strip 209.

The expansion plug 422 of the pluggable magnetic gasket assembly 119B is flexible and can contract in size to fit through the narrow surface groove 416A into the expansion groove 416B. Once in the expansion groove 416B, the expansion plug 422 expands out to couple the pluggable magnetic gasket assembly 119B to the door 116B.

Referring now to FIG. 4C, a cross section of a magnetic gasket assembly 119C is shown coupled to a retaining strip 319C and a hinged door 116C. The retaining strip 319C is coupled to the door 116 with a plurality of fasteners 320. The retaining strip 319C includes a base portion 428 and a straight tongue portion 429 extending from the base portion. The straight tongue portion 429 is spaced apart and parallel to the back side surface of the door. The straight tongue portion 429 forms a groove 439 between the door surface and tongue portion around the periphery of the door. The groove 439 is configured to receive a retaining strip 449 of the magnetic gasket assembly 119C.

When mounted, the retaining strip 449 of the magnetic gasket assembly 119C wraps around the tongue portion 429 and engages the top surface of the base portion 428 of the retaining strip 319C. The retaining strip 449 is coupled to the mounting gasket component 202C of the magnetic gasket assembly 119C. The magnetic gasket assembly 119C includes the spring gasket component 204 coupled to the mounting gasket component 202C and the interfacing gasket component 206 coupled to the spring gasket component 204. The interfacing gasket component 206 includes the flexible magnetic strip 209.

### Double Door Assembly

FIGS. 1A-1B illustrate a food storage cabinet 100 with a single door 116 and a single storage capacity. Alternatively, a double door configuration of a food storage cabinet may be formed to increase the storage capacity, such as doubling the storage capacity of the food storage cabinet 100.

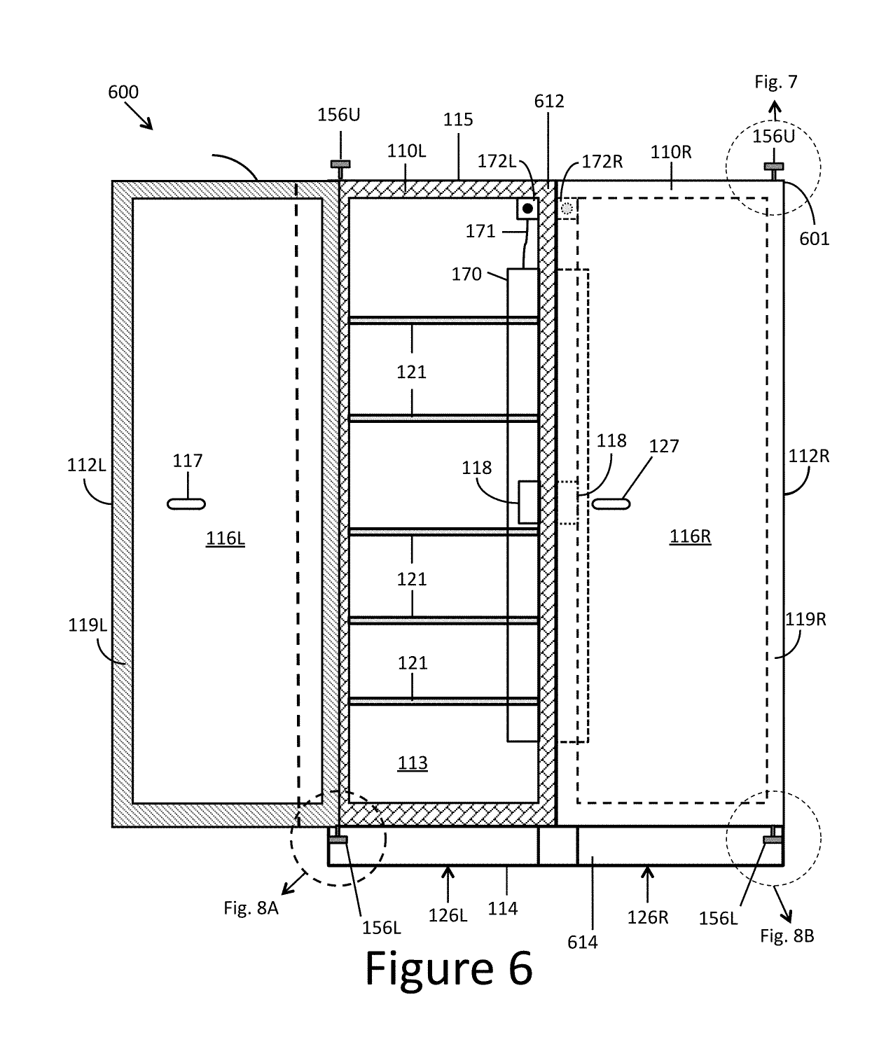

Referring now to FIG. 6, a food storage cabinet 600 with two hinged doors 116L and 116R is shown to provide for increased storage capacity over that of food storage cabinet 100. In accordance with some embodiments, the food storage cabinet 600 may measure 6 feet high, 8 feet wide, and 2 feet deep. In other embodiments, the food storage cabinet 600 may have other dimensions.

In FIG. 6, the right hinged door 116R is in the closed configuration while the left hinged door 116L is in the open configuration so you can see part of the interior of the cabinet 600. The food storage cabinet 600 further includes the left side 112L, the right side 112R, the top 113, the bottom or base 114, and a center panel 612 all coupled to the back side or back wall 111.

Similar to the cabinet 100, the cabinet 600 includes one or more shelves 121 and the light bar 170. With double doors, the cabinet 600 includes left and right switches 172L,172R coupled between the power supply (e.g., battery pack or battery eliminator) and light bar 170. If either door 116L,116R is opened, the power is coupled into the light bar to illuminate the interior of the cabinet. If both doors are closed, power is decoupled from the light bar 170 to conserve power. With double doors, the cabinet further includes a pair of handles 127 with a controlled latch 117 in each door to interface to a catch 118 on each side of the cabinet. Each of the handles 127 may include a key lock to prohibit rotation when in the locked position with the latch 117 engaged with the catch 118.

The sealable storage cabinet 600 includes a left rectangular edge 110L formed by edges of the left side 112L, the top 113, the bottom or base 114, and the center panel 612. The sealable storage cabinet 600 includes a right rectangular edge 110R formed by the edges of the right side 112R, the top 113, the bottom or base 114, and the center panel 612. The left hinged door 116L includes a left magnetic gasket assembly 119L around its periphery. The right hinged door 116R includes a right magnetic gasket assembly 119R around its periphery. The left magnetic gasket assembly 119L of the left hinged door 116L seals around the left rectangular edge 110L and the right magnetic gasket assembly 119R seals around the right rectangular edge 110R. The left magnetic gasket assembly 119L and the right magnetic gasket assembly 119R each include elements of the magnetic gasket assembly 119 with the flexible magnet 209. The left magnetic gasket assembly 119L and the right magnetic gasket assembly 119R may be coupled to the left and right doors 116L,116R in the various ways discussed herein.

To attract the flexible magnet 209 in each of the left magnetic gasket assembly 119L and the right magnetic gasket assembly 119R towards the housing 601, the edges of the left side 112L, the right side 112R, the top 113, the bottom or base 114, and the center panel 612 include the metallic strip 219 shown in FIG. 2.

The sealable storage cabinet 600 may include top hinges 156U and bottom hinges 156L,156R, to support and pivotally couple the doors 116L,116R to the housing 601. The doors 116L,116R can pivot around the pins of the hinges 156U,156L,156R between an open configuration/state such as shown by the door 116L in FIG. 6 and a closed configuration/state such as shown by the door 116R in FIG. 6 avoiding interference with the magnetic seal assemblies 119L,119R mounted to the inside surface of the hinged doors 116L,116R. The housing 601 may include a bottom panel 614 to elevate the doors 116L,116R up to allow room to mount the bottom hinges 156L,156R below the doors.

### Alternate Hinges

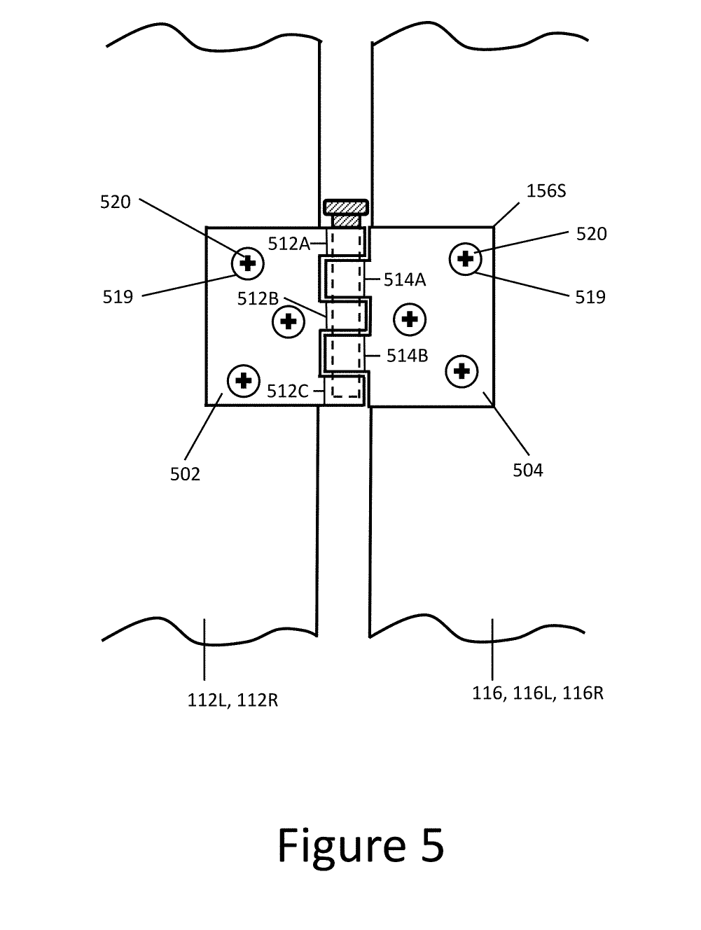

Referring now to FIG. 5, a portion of a food storage cabinet is shown with a side hinge 156S. The side hinge 156S may be used for either the single door configuration or double door configuration of the food storage cabinet 100,600. The side hinge 156S is mounted to the outside surfaces of the side panel 112L,112R and the hinged door 116,116L,116R of the food storage cabinet. In this manner, the side hinge 156 avoids interference with the magnetic seal assembly 119 mounted to the inside surface of the hinged door 116,116L,116R.

The side hinge 156S includes a first pivotal half 502 and a second pivotal have 504 pivotally coupled together by a pin 506 along a pivot axis. The first pivotal half 502 includes a first plurality of cylinders 512A-512C configured to receive the pin 506. The second pivotal half 504 includes a second plurality of cylinders 514A-514B configured to receive the pin 506. The first plurality of cylinders 512A-512C are interlaced with the second plurality of cylinders 514A-514B to concurrently receive the pin and pivotally couple the first pivotal half 502 and the second pivotal have 504 together.

The first pivotal half 502 further includes a first plurality of holes 519 each configured to receive a fastener 519 to couple it to the outside surface of either the side panel 112L for left side pivoting or the side panel 112R for right side pivoting. The second pivotal half 504 further includes a second plurality of holes 519 each configured to receive a fastener 519 to couple it to the outside surface of the hinged door 116.

Alternatively, top hinges 156U and bottom hinges 156L,156R, such as shown in FIG. 6, may be used for either the single door configuration or double door configuration of the food storage cabinet 100,600.

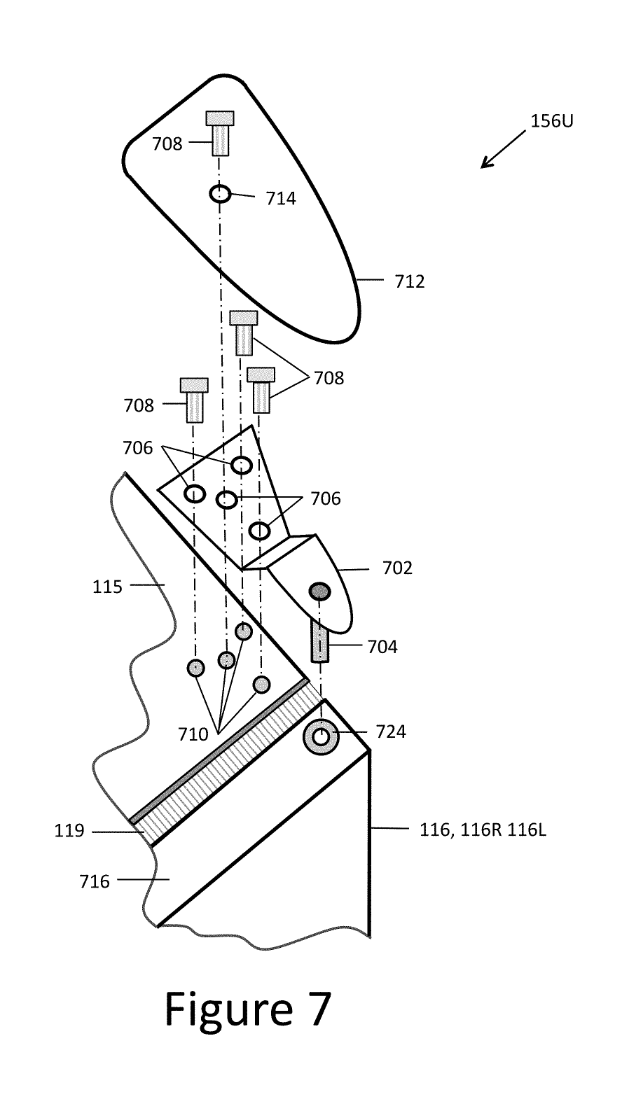

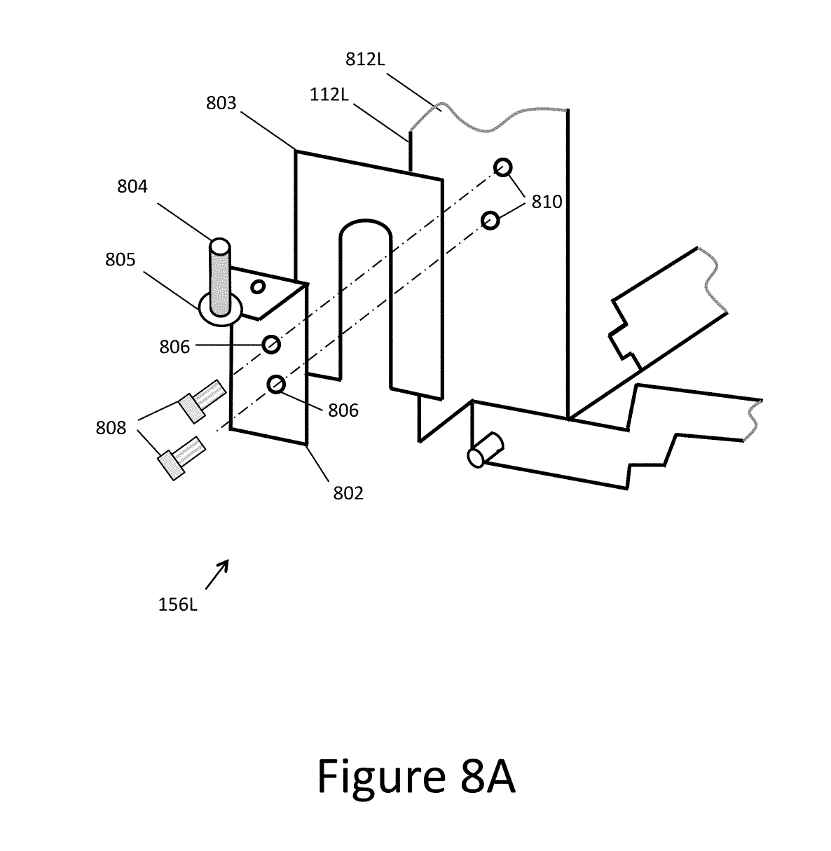

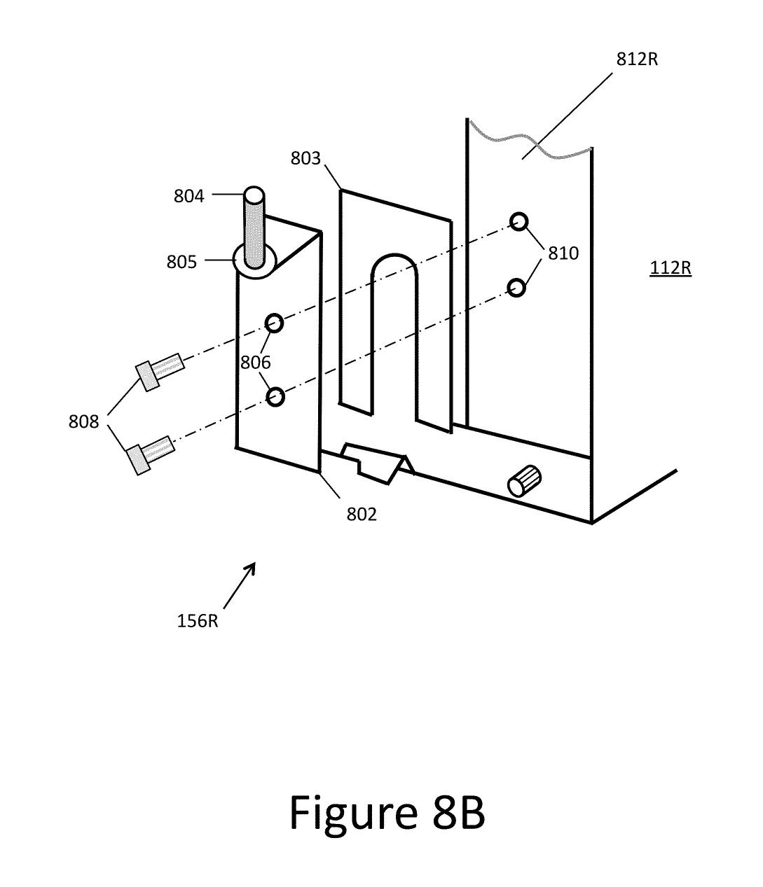

Referring now to FIGS. 7 and 8A-8B, top and bottom hinges 156U,156L,156R are now discussed for the single door configuration and the double door configuration of the food storage cabinet 100,600. In the single door configuration, a single top hinge 156U and a single bottom hinge 156L,156R are used for one hinged door 116. In the double door configuration, a top hinge 156U and a left bottom hinge 156L are used for the left hinged door 116L and a second top hinge 156U and a right bottom hinge 156R are used for the right hinged door 116R.

In FIG. 7, an exploded view of the top hinge 156U is shown. The top hinge 156U includes a bracket 702 having a base portion and a tongue portion with a downward pivot pin 704. The base portion of the bracket 702 includes a plurality of holes 706 through which a plurality of threaded male fasteners 708 may pass. The top 115 of the cabinet includes a plurality of holes 710 to receive the plurality of male threaded fasteners 708. The top hinge 156U may include a cover 712 that covers over the bracket 702. The cover 712 includes an opening 714 through which another threaded male fastener 708 may pass into a hole 710 in the top 115 of the cabinet.

To mount the door to the hinge, a top edge 716 of the door 116,116R,116L has a pivot hole 724 configured to receive the pivot pin 704. The pivot hole 724 is located near a side edge of the door. The pivot hole 724 may be reinforced with a metal bushing.

To allow doors 116,116R,116L to be installed and removed after the bracket 702 is coupled to the top 115 of the cabinet, the tongue portion of the bracket 702 with the pivot pin may be offset from the base portion of the bracket by a neck portion. In this case, a user may then be able to lift up a door sliding it further onto the top pivot pin 704 releasing the door from a bottom pivot pin in the bottom hinge so that it can be decoupled from the housing 101,601 of the cabinet.

Referring now to FIG. 8A, a bottom hinge 156L is mounted to an edge 812L of the left side 112L of the cabinet below the door 116L. The bottom hinge 156L includes a bracket 802 having a base portion and a tongue portion perpendicular to the base portion. The tongue portion of the bracket 802 includes an upward pivot pin 804. A plastic washer 805 may be mounted over the upward pivot pin 804 before the pivot hole (e.g., pivot hole 724 in FIG. 7) in the bottom edge of the door is mounted over the upward pivot pin 804. The plastic washer reduces friction between a metal bracket 802 and a plastic door when pivoted to reduce wear. The base portion of the bracket 802 has a plurality of holes 806 through which a plurality of male threaded fasteners 808 may pass. The edge 812L of the side 112L includes a plurality of holes 810 to receive the plurality of male threaded fasteners 808.

The bottom hinge 156L may further include a U-shaped support bracket 803 mounted between the hinge bracket 802 and the edge 812L of the side 112L. The U-shaped support bracket 803 may support the hinge bracket 802 and protect the plastic edge of the side from wear. The U-shaped support bracket 803 can spread the force on the hinge bracket from the weight of the door over a larger surface area of the edge 812L.

In FIG. 8B, a bottom hinge 156R is mounted to an edge 812R of the right side 112R of the cabinet below the door 116R. The bottom hinge 156R is similar to the bottom hinge 156L and includes the bracket 802 having a base portion and a tongue portion with the upward pivot pin 804 perpendicular to the base portion. The edge 812R of the side 112R includes the plurality of holes 810 to receive the plurality of male threaded fasteners 808 extending through the holes 806 in the bracket 802. A plastic washer 805 may be mounted over the upward pivot pin 804 before the pivot hole (e.g., pivot hole 724 in FIG. 7) in the bottom edge of the door is mounted over the upward pivot pin 804. The bottom hinge 156R may further include a U-shaped washer 803 mounted between the bracket 802 and the edge 812L of the side 112L.

### Light Assembly

Some embodiments of the food storage cabinets disclosed herein include an interior lighting system that is responsive to the open and closed configuration/state of the cabinet and door. The lighting system is switched ON to provide light within the cabinet when at least one hinged door is opened. The lighting system is turned OFF when one or both hinged doors are closed. When the hinged door or doors are opened, the light allows a person to clearly see the stored contents within the sealable storage cabinet such as dry food.

Referring now to FIGS. 1A and 6 the lighting system in the sealable storage cabinet 100,600 is now described. The lighting system includes a light bar 170 coupled to the back wall 113 of the sealable storage cabinet 100,600. The lighting system further includes one or more switches 172,172L,172R; a battery pack power source 174; and a wall charger 176 coupled together by cables 173,175.

A cable 171 is coupled to and between the one or more switches 172,172L,172R and the light bar 170. A power cable 173 is coupled to and between the battery pack power source 174 and the one or more switches 172,172L,172R. A charger cable 175 is coupled to and between the wall charger 176 and the battery pack power source 174.

When a hinged door 116,116L,116R is opened, a switch 172,172L,172R closes coupling power from the battery pack 174 to the light bar 170. When the hinged door is closed, the switch is opened and power from the battery pack 174 is decoupled from the light bar 170. In this manner, the interior of the hermetically sealed food storage cabinet 100,600 is illuminated in response to a hinged door 116,116L,116R being opened.

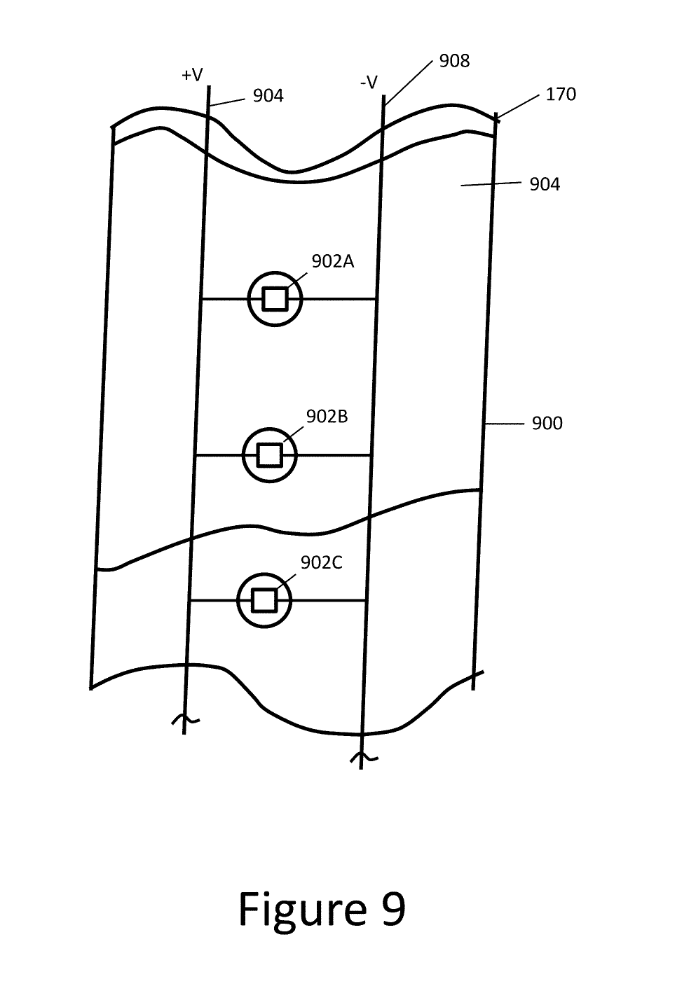

Referring now to FIG. 9, the light bar 170 comprises a housing 900 with a plurality of lamps 902A-902C and a clear bezel diffuser 904 coupled to the housing 900 covering over the lamps. An electrical wire Vplus 906 to carry a positive supply voltage and an electrical wire Vminus 908 to carry a negative supply voltage or ground are coupled to each of the plurality of lamps in the light bar. The pair of electrical wires 906,908 are routed in the cable 171 to each of the one or more switches 172,172L,172R in the sealable storage cabinets. Power is selectively applied to all the lamps in the light bar through the one or more switches in response to a hinged door 116,116L,116R being in an open state.

The plurality of lamps 902A-902C in the light bar may be light emitting diodes (LEDs) or laser diodes. The direct light from an LED or laser diode can be rather collimated and harsh when viewed directly by a user's eyes. The clear bezel diffuser 904 over the plurality of lamps diffuses the light out at different angles thereby softening the light within the sealable storage cabinet.

### Alternate Cabinents

FIGS. 1A-1B and 6 illustrate side swinging doors for food storage cabinets 100,600 to cover over open face openings and access food through a side opening. However, a food storage cabinet may be configured to have a top side open face with a closable top instead to access food through a top opening.

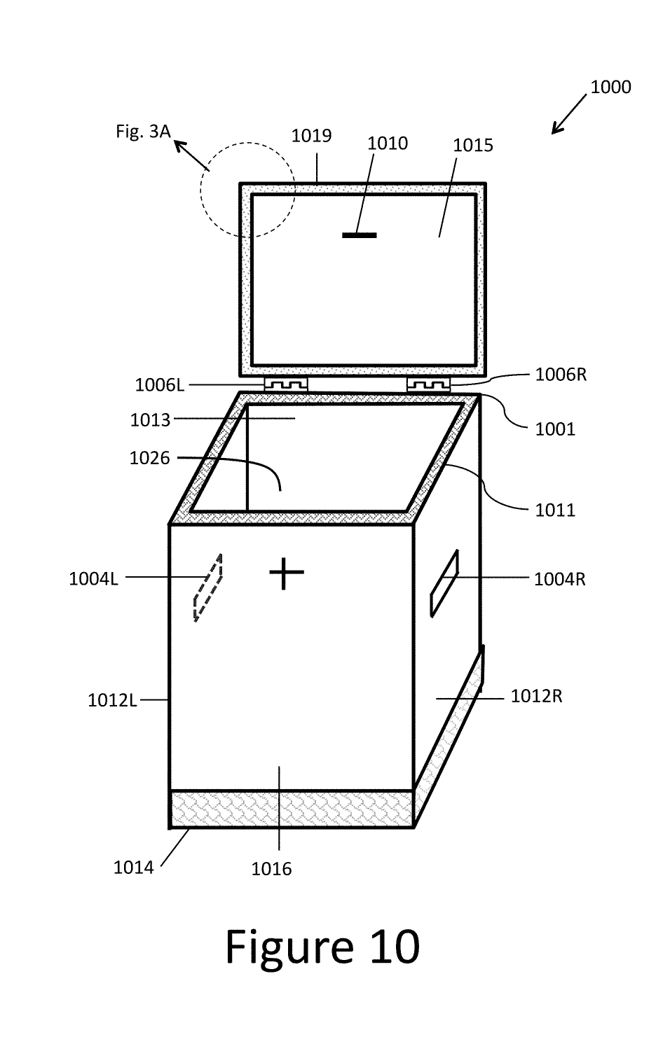

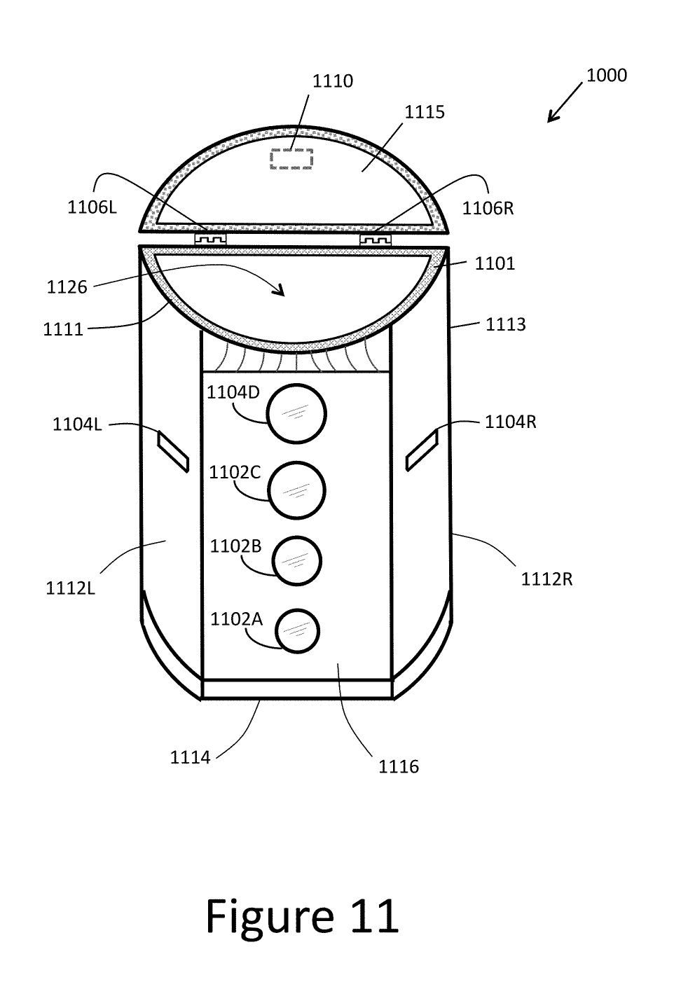

Referring now to FIGS. 10-11, alternate embodiments of food storage cabinets with a magnetic gasket assembly are shown. In FIG. 10, a perspective view of a hermetically sealable food storage box 1000 is shown in an open lid configuration/state. Generally, the food storage box 1000 includes two side walls 1012L,1012R, a back wall 1013, a front wall 1016, a bottom 1014, and a hinged top lid 1015 coupled to the back wall 1013. The hinged top lid 1015 is configured to cover over the opening of the open top 1026 of the food storage cabinet 1000. The hermetically sealable food storage box 1000 includes a magnetic gasket assembly 1019, similar to the magnetic gasket assembly 119 described herein, coupled to an inner surface of the hinged top lid 1015.

The two side walls 1012L,1012R, the back wall 1013, the bottom 1014, and the front wall 1016 form a housing or body 1001 of the food storage cabinet 1000. Top edges of the two side walls 1012L,1012R, the back wall 1013, the bottom 1014, and the front wall 1016 form a rectangular edge 1011. The rectangular edge 1011 includes a rectangular metal strip (e.g., see metal strip 219 in FIG. 2) to attract the flexible magnet in the magnetic gasket assembly 1019.

For ready movability, a set of handles 1004L,1004R are coupled to the sides 1012L,1012R of the food storage box 1000. To ease opening the hinged top lid 1015 in overcoming the attraction of the flexible magnet to the metal strip, a lid handle 1010 is coupled to the outer surface of the hinged top lid. To ease reaching into the food storage box 1000, the height of the front wall 1016 is less than the height of the back wall 1013. Accordingly, the sides 1012L,1012R of the food storage box 1000 are trapezoids with each having one pair of parallel edges.

Components of the of the food storage box 1000, including the housing or body 1001, may be fabricated from wood, plastic or metal. Portions of the hinged top lid 1016 may also be fabricated from wood, plastic or metal.

The food storage cabinet 1000 has two configurations/states. In an open configuration shown in FIG. 10, an individual can access non-refrigerated and dry food goods (not shown) contained within the food storage cabinet 1000. In the closed configuration, the top lid 1015 of the food storage cabinet 1000 is shut closing over the top opening 1026. In the closed configuration/state, the magnetic gasket assembly 1019 forms a substantial air-tight seal around the edges of the top lid 1015 and the rectangular edge 1011 of the housing 1001.

Referring now to FIG. 11, a perspective view of a hermetically sealable food storage canister 1100 is shown in an open lid configuration. The food storage canister 1100 may be somewhat shaped in a semicircle cylinder. Generally, the food storage canister 1100 includes two side walls 1112L,1112R, a back wall 1113, a front wall 1116, a bottom 1114, and a hinged top lid 1115 coupled to the back wall 1113. The two side walls 1112L,1112R, the back wall 1113, and the front wall 1116 coupled together form a top edge 1111. The two side walls 1112L,1112R may be arched or curved while a majority of the front wall 1116 is flat from the bottom up and transitioning into a curved portion of the edge 1111. The two side walls 1112L,1112R, the back wall 1113, the bottom 1114, and the front wall 1116 form a housing or body 1101 of the food storage canister 1100.

The hinged top lid 1115 is configured to cover over the opening of the open top 1126 of the food storage canister 1100. The hinged top lid 1115 may coupled to the back wall 1113 by a plurality of hinges 1106L,1106R. The hinges 1106L,1106R may be similar to the side hinge 156S show in FIG. 5 coupled to outside surfaces of the lid 1115 and back wall 1113. The food storage canister 1100 further includes a magnetic gasket assembly 1119 coupled to the inner surface of the hinged top lid 1115 around its peripheral edges. The magnetic gasket assembly 1119, similar to the magnetic gasket assembly 119 described herein, includes a flexible magnetic and is configured to seal to the edge 1111. The edge 1111 includes a metal strip (e.g., see metal strip 219 in FIG. 2) to attract the flexible magnet in the magnetic gasket assembly 1119.

To ease opening the hinged top lid 1115 in overcoming the attraction of the flexible magnet to the metal strip, a lid handle 1110 is coupled to the outer surface of the hinged top lid. A pair of side handles 1104L,1104R are respectively coupled to the sides 1012L,1012R of the food storage canister 1100. With the side handles 1104L,1104R, the food storage canister 1100 can be readily moved around.

Portions of the housing or body 1101 may be fabricated from wood, plastic or metal. Portions of the hinged top lid 1016 may also be fabricated from wood, plastic or metal.

FIG. 11 illustrates the food storage canister 1100 in an open configuration/state with the hinged lid 1115 pivot away from the open top 1126. In the open configuration/state, an individual can access non-refrigerated and dry food goods (not shown) contained within the food storage canister 1100. In the closed configuration, the top lid 1115 of the food storage canister 1100 is shut, such that the magnetic gasket assembly 1119 forms an air-tight seal around the edges of the top lid 1115 and the edge 1111 of the housing 1101 around the open top 1126.

The food storage canister 1100 further includes a plurality of clear plastic windows 1102A-1102D sealed into openings of the front wall 1116. An approximate level of dry food goods contained within the food storage canister 1100 can be seen through the clear plastic windows 1102A-1102D. Accordingly, in the closed configuration/state, without opening the top lid, a user can visualize and gauge an approximate amount of dry food goods remaining within the food storage canister 1100 through the clear plastic windows 1102A-1102D. In response to a level below the second window 1102B, a user can be alerted to soon purchase additional dry food goods to restore the level above the second window 1102B.

### Conclusion

There are a number of advantages of a hermetically sealable food storage cabinet. One advantage is that it provides food storage where none may have previously existed for dry foods, such as a garage of a home. Another advantage is that it prevents access to insects and rodents. Another advantage is that it deters dirt and dust from accumulating inside and mixing into the dry foods. Another advantage is that it is lower in costs than remodeling a home to provide food storage capacity or purchasing a refrigerator in which to store additional food.

While the embodiments of the sealable storage cabinet have been described as food storage cabinets to store dry foods, the sealable storage cabinets can be adapted and used to store other items such as clothes, antiques, compact discs, DVDs, and other valuable items in a dirt and bug resistant cabinet.

While certain exemplary embodiments have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

For example, certain features that may be described in the context of separate implementations may also be implemented in combination in a single implementation. Conversely, various features that may be described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1. A hermetically sealable storage cabinet for housing non-refrigerated food, the hermetically sealable storage cabinet comprising:
a rectangular housing having side walls, a back wall, a bottom, and a top coupled together forming an open front side with a rectangular edge into a storage compartment, the rectangular edge having a metal strip;
at least one rectangular door to cover over the open front side of the rectangular housing, each of the at least one rectangular door has a rectangular peripheral edge;
a plurality of hinges coupled between the least one rectangular door and the rectangular housing;
at least one magnetic gasket coupled to an inner side of each least one rectangular door near the rectangular peripheral edge, the at least one magnetic gasket including a flexible magnet attracted to metal;
a light bar coupled to the back of the rectangular housing, the light bar including a plurality of lamps switched on in response to an open configuration of the at least one rectangular door to provide lighting within the storage compartment;
wherein in a closed configuration the at least one rectangular door covers over the open front side of the rectangular housing and the flexible magnet of the at least one magnetic gasket is attracted to the metal strip of the rectangular edge of the rectangular housing such that the rectangular magnetic gasket forms an air-tight seal between the rectangular edge of the rectangular housing and the rectangular peripheral edge of the least one rectangular door;
wherein the hermetically sealable storage cabinet lacks refrigeration and is for storing non-refrigerated food.

2. The hermetically sealable storage cabinet according to claim 1, further comprising:
a set of caster wheels coupled to the bottom of the rectangular housing, the set of caster wheels providing ready movability of the hermetically sealable storage cabinet.

3. The hermetically sealable storage cabinet according to claim 1, wherein the rectangular housing is wood, metal or plastic.

4. The hermetically sealable storage cabinet according to claim 1, further comprising:
a plurality of shelves in the storage compartment coupled to the rectangular housing, the plurality of shelves to support the storage of various sized containers of non-refrigerated food in the storage compartment.

5. The hermetically sealable storage cabinet according to claim 1, wherein the plurality of hinges coupled between the at least one rectangular door and the rectangular housing are side hinges.

6. The hermetically sealable storage cabinet according to claim 1, wherein the plurality of hinges coupled between the at least one rectangular door and the rectangular housing are at least one top hinge coupled between a top edge of the at least one rectangular door and the top of the rectangular housing and at least one bottom hinge coupled between a bottom edge of the at least one rectangular door and the bottom of the rectangular housing.

7. The hermetically sealable storage cabinet according to claim 1, wherein
each inner side of the at least one rectangular door includes a L-shaped retaining strip around the rectangular peripheral edge; and
the at least one magnetic gasket further includes a groove coupled to the L-shaped retaining strip.

8. The hermetically sealable storage cabinet according to claim 1, wherein
each inner side of the at least one rectangular door includes a retaining strip around the rectangular peripheral edge forming a rectangular groove; and
the at least one magnetic gasket further includes a retaining clip coupled into the groove of the retaining strip.

9. The hermetically sealable storage cabinet according to claim 1, wherein
each inner side of the at least one rectangular door includes a groove around the rectangular peripheral edge; and
the at least one magnetic gasket further includes a fastener coupled into the groove around the rectangular peripheral edge of each at least one rectangular door.

10. The hermetically sealable storage cabinet according to claim 1, wherein
the at least one rectangular door includes a pivotal handle coupled to a pivotal latch; and
the cabinet further comprises
a catch coupled to a side of the rectangular housing opposite the plurality of hinges, the catch to receive the pivotal latch and hold the at least one rectangular door in the closed configuration.

11. The hermetically sealable storage cabinet according to claim 10, wherein
the pivotal handle is a lockable pivotal handle configured to receive a key and deter rotation when in a locked mode.

12. The hermetically sealable storage cabinet according to claim 1, further comprising:
a power supply;
a switch coupled to a side of the rectangular housing opposite the plurality of hinges, the switch electrically coupled to and between the power supply and the light bar, the switch configured to turn OFF opening a circuit between the power supply and the light bar when in the closed configuration and to turn ON closing a circuit between the power supply and the light bar when in the open configuration.

13. A hermetically sealable storage cabinet for housing non-refrigerated items, the hermetically sealable storage cabinet comprising:
a housing having left and right sides, a back side, a front side, and a bottom coupled together forming an open end in a top side with a peripheral edge into a storage compartment, the peripheral edge having a metal strip;
a pivotal door to cover over the open end of the housing, the pivotal door having an inner surface and a peripheral edge;
a plurality of hinges coupled to and between the pivotal door and the housing; and
a magnetic gasket coupled to the inner surface of the pivotal door around and near the peripheral edge of the pivotal door, the magnetic gasket including a flexible magnet attracted to metal;
wherein in a closed configuration the pivotal door covers over the open end of the housing and the flexible magnet of the magnetic gasket is attracted to the metal strip of the peripheral edge of the housing such that the magnetic gasket forms an air-tight seal between the peripheral edge of the housing and the peripheral edge of the pivotal door;
wherein the hermetically sealable storage cabinet lacks refrigeration to store perishable food.

14. The hermetically sealable storage cabinet according to claim 13, wherein
the hermetically sealable storage cabinet is a hermetically sealable food storage cabinet for storing dry food;
the front side of the housing includes a plurality of openings between the bottom and the peripheral edge of the housing; and
the cabinet further comprises
a plurality of windows sealed into the plurality of openings in the front side of the housing, the plurality of windows providing a visible gauge of a level of the dry food stored in the cabinet.

15. The hermetically sealable storage cabinet according to claim 13, wherein
the housing has a semi-circle cylindrical shape at the peripheral edge of the housing; and
the pivotal door is a top hinged pivotal door with a semi-circle cylindrical shape to cover over the open end of the housing.

16. The hermetically sealable storage cabinet according to claim 13, further comprising:
a top handle coupled to an outer surface of the pivotal door, the top handle configured to receive one or more fingers of a hand to leverage open the pivotal door;
a pair of side handles coupled to the sides of housing, each of the side handles configured to receive a plurality of fingers of each hand to lift and carry the hermetically sealable storage cabinet from place to place.

17. The hermetically sealable storage cabinet according to claim 13, wherein
each side of the housing has a trapezoidal shape;
the peripheral edge of the housing has a rectangular shape; and
the pivotal door is a top hinged pivotal door with a rectangular shape to cover over the open end of the housing.

18. The hermetically sealable storage cabinet according to claim 13, wherein
each side of the housing has a trapezoidal shape;
the peripheral edge of the housing has a rectangular shape; and
the pivotal door is a top hinged pivotal door with a rectangular shape to cover over the open end in the top side of the housing.

19. The hermetically sealable storage cabinet according to claim 18, wherein the front side of the housing is shorter than the back side of the housing to ease entry into entry into the storage compartment.

20. The hermetically sealable storage cabinet according to claim 19, further comprising:
a top handle coupled to an outer surface of the top hinged door, the top handle configured to receive one or more fingers of a hand to leverage open the top hinged door;
a pair of side handles coupled to the sides of housing, each of the side handles configured to receive a plurality of fingers of each hand to lift and carry the hermetically sealable storage cabinet from place to place.
